(19) United States
(12) Patent Application Publication
(10) Pub. No.: US 2024/0145772 A1
(43) Pub. Date: May 2, 2024

(54) Cross-Linkable Solid Electrolyte Membrane for All-Solid-State Batteries and Method of Manufacturing the Same

(71) Applicants: Hyundai Motor Company, Seoul (KR); Kia Corporation, Seoul (KR); IUCF-HYU (Industry-University Cooperation Foundation Hanyang University), Seoul (KR)

(72) Inventors: So Yeon Kim, Suwon-si (KR); Yun Sung Kim, Hwaseong-si (KR); Ga Hyeon Im, Hwaseong-si (KR); Yoon Kwang Lee, Ansan-si (KR); Hong Seok Min, Yongin-si (KR); Kyu Joon Lee, Seoul (KR); Dong Won Kim, Seoul (KR); Young Jun Lee, Seoul (KR); Hui Tae Sim, Seoul (KR); Seung Bo Hong, Seoul (KR)

(21) Appl. No.: 18/467,433

(22) Filed: Sep. 14, 2023

(30) Foreign Application Priority Data
Nov. 2, 2022 (KR) 10-2022-0144184

(51) Int. Cl. H01M 10/0562; C01B 17/22; C01G 53/00; H01M 4/38; H01M 4/505; H01M 4/525; H01M 10/0585

(52) U.S. Cl. CPC H01M 10/0562; C01B 17/22; C01G 53/50; H01M 4/382; H01M 4/505; H01M 4/525; H01M 10/0585; H01M 2004/027; H01M 2300/008

(57) ABSTRACT

An embodiment composition for solid electrolyte membranes of all-solid-state batteries includes a sulfide-based solid electrolyte and a cross-linking agent including two or more acrylate functionalities. An embodiment method of manufacturing a solid electrolyte membrane for an all-solid-state battery includes forming a composition including a sulfide-based solid electrolyte and a cross-linking agent including two or more acrylate functionalities and cross-linking the composition.

### CROSS-REFERENCE TO RELATED APPLICATIONS

This application claims the benefit of Korean Patent Application No. 10-2022-0144184, filed on Nov. 2, 2022, which application is hereby incorporated herein by reference.

### TECHNICAL FIELD

The present disclosure relates to a composition for solid electrolyte membranes of all-solid-state batteries, a solid electrolyte membrane including the same, and a method of manufacturing the same.

### BACKGROUND

An all-solid-state battery is a lithium secondary battery using a solid electrolyte instead of an organic liquid electrolyte having a great risk of fire.

A solid electrolyte membrane of the all-solid-state battery is generally manufactured to a thickness of 500 μm or more and is thus disadvantageous in terms of output characteristics and energy density compared to a lithium ion battery. Further, since a sulfide-based solid electrolyte is expensive, the solid electrolyte membrane having a large thickness is an obstacle to commercialization in terms of costs.

In order to increase the energy density of the all-solid-state battery, research on reduction in the thickness of the solid electrolyte membrane is underway. As methods of reducing the thickness of solid electrolyte membranes, a solid electrolyte membrane may be impregnated with a porous polymer support, or a hydrophobic polymer binder may be used. However, polymers used in the above techniques do not have lithium ion conductivity and thus disturb migration of lithium ions in the solid electrolyte membrane and cause performance deterioration of the all-solid-state battery.

The above information disclosed in this background section is only for enhancement of understanding of the background of embodiments of the invention and therefore it may contain information that does not form the prior art that is already known to a person of ordinary skill in the art.

### SUMMARY

The present disclosure has been made in an effort to solve the above-described problems associated with the prior art, and an embodiment of the present disclosure provides a solid electrolyte membrane for all-solid-state batteries which has a small thickness.

Another embodiment of the present disclosure provides a solid electrolyte membrane for all-solid-state batteries which has excellent mechanical properties, such as hardness and flexibility.

Another embodiment of the present disclosure provides a solid electrolyte membrane for all-solid-state batteries which has excellent lithium ion conductivity.

Another embodiment of the present disclosure provides a solid electrolyte membrane for all-solid-state batteries which has high stability to a lithium anode.

A further embodiment of the present disclosure provides a solid electrolyte membrane for all-solid-state batteries which has excellent charging and discharging characteristics.

One embodiment of the present disclosure provides a composition for solid electrolyte membranes of all-solid-state batteries including a sulfide-based solid electrolyte and a cross-linking agent including two or more acrylate functionalities.

The sulfide-based solid electrolyte may include at least one selected from the group consisting of Li₆PS₅X (X═Cl, Br or I), Li₁₀GeP₂S₁₂, Li₃PS₄, Li₇P₃S₁₁, and combinations thereof.

The cross-linking agent may include at least one selected from the group consisting of tetraethylene glycol diacrylate (TEGDA), polyethylene glycol diacrylate (PEGDA), trimethylolpropane trimethacrylate, and combinations thereof.

The content of the cross-linking agent may be 10 parts by weight to 15 parts by weight based on 100 parts by weight of the sulfide-based solid electrolyte.

The composition may further include a lithium salt, and the lithium salt may include at least one selected from the group consisting of LiN(SO₂F)₂, LiN(SO₂C₂F₅)₂, LiN(SO₂C₂F₃)₂, LiN(CF₃SO₂)₂, LiPF₆, LiBF₄, LiClO₄, LiCF₃SO₃, LiC₄F₉O₃, LiC₆H₅SO₃, LiSCN, LiB(C₂O₄)₂, LiPO₂F₂, and combinations thereof.

The content of the lithium salt may be 15 parts by weight to 20 parts by weight based on 100 parts by weight of the sulfide-based solid electrolyte.

The composition may further include a solvent, and the solvent may include at least one selected from the group consisting of N-butyl butyrate, benzyl acetic acid, 1,4-dichlorobutane, dichlorobenzene, and combinations thereof.

The composition may further include an initiator, and the initiator may include at least one selected from the group consisting of t-amyl-based compounds, azobis-based compounds, and combinations thereof.

Another embodiment of the present disclosure provides a solid electrolyte membrane for all-solid-state batteries including a cross-linked product of the above-described composition.

The solid electrolyte membrane may be a self-supporting membrane.

The solid electrolyte membrane may have a thickness of 50 μm to 250 μm.

Still another embodiment of the present disclosure provides a method of manufacturing a solid electrolyte membrane for all-solid-state batteries including cross-linking the above-described composition.

The composition may be heated to a temperature of 50° C. to 90° C. so as to be cross-linked.

Yet another embodiment of the present disclosure provides an all-solid-state battery including the above-described solid electrolyte membrane, a cathode located on one surface of the solid electrolyte membrane, and an anode located on a remaining surface of the solid electrolyte membrane.

The anode may include lithium metal or a lithium alloy.

The anode may have a thickness of 10 μm to 200 μm.

The cathode may include a cathode active material, and the cathode active material may include at least one selected from the group consisting of LiCoO₂, Li(NiₓCo_{y}Mn_{z})O₂ (x+y+z=1), Li(NiₓCo_{y}Al_{z})O₂ (x+y+z=1), LiFePO₄, and combinations thereof.

Other aspects and preferred embodiments of the invention are discussed infra.

The above and other features of embodiments of the invention are discussed infra.

### BRIEF DESCRIPTION OF THE DRAWINGS

The above and other features of embodiments of the present disclosure will now be described in detail with reference to certain exemplary embodiments thereof illustrated in the accompanying drawings which are given hereinbelow by way of illustration only and thus are not limitative of the present disclosure, and wherein:

FIG. 1 shows an all-solid-state battery according to embodiments of the present disclosure;

FIG. 2 shows a solid electrolyte membrane according to embodiments of the present disclosure;

FIG. 3 shows the result of observation of a solid electrolyte membrane according to Comparative Example 2;

FIG. 4 shows the result of observation of a solid electrolyte membrane according to Example 1;

FIG. 5 shows the result of observation of a solid electrolyte membrane according to Example 2;

FIG. 6 shows Raman spectroscopy analysis of the solid electrolyte membrane according to Example 1 before and after thermal cross-linking;

FIG. 7 shows infrared spectroscopy analysis of the solid electrolyte membrane according to Example 1 before and after thermal cross-linking;

FIG. 8 shows the result of observation of a solid electrolyte membrane according to Comparative Example 3;

FIG. 9 shows the result of observation of a solid electrolyte membrane according to Comparative Example 4;

FIG. 10 shows the result of observation of a solid electrolyte membrane according to Example 3;

FIG. 11 shows the result of observation of a solid electrolyte membrane according to Example 4;

FIG. 12 shows a graph representing the results of measurement of conductance of the solid electrolyte membranes according to Comparative Examples 1, 3, and 4 and Examples 1, 3, and 4;

FIG. 13 shows scanning electron microscopy (SEM) analysis and energy dispersive X-ray spectroscopy (EDX) analysis of the cross-section of the solid electrolyte membrane according to Example 3;

FIG. 14 shows X-ray diffraction analysis of the solid electrolyte membranes according to Comparative Example 1 and Examples 1 and 3;

FIG. 15 shows Raman spectroscopy analysis of the solid electrolyte membranes according to Comparative Example 1 and Examples 1 and 3;

FIG. 16 shows the results of nanoindentation measurement of the solid electrolyte membranes according to Comparative Example 1 and Example 3;

FIG. 17 shows the hardness of the solid electrolyte membranes according to Comparative Example 1 and Example 3;

FIG. 18 shows the results of evaluation of electrochemical stability of the solid electrolyte membrane according to Comparative Example 1;

FIG. 19 shows the results of evaluation of electrochemical stability of the solid electrolyte membrane according to Example 3;

FIG. 20 shows the result of evaluation of cell performance of the solid electrolyte membrane according to Example 3 at a specific current density;

FIG. 21 shows the results of evaluation of cell performance of the solid electrolyte membrane according to Example 3 while varying the current density;

FIG. 22 shows initial charging and discharging curves of all-solid-state batteries including the solid electrolyte membranes according to Comparative Example 1 and Example 3; and

FIG. 23 shows the discharge capacities of the all-solid-state batteries including the solid electrolyte membranes according to Comparative Example 1 and Example 3 in respective cycles.

It should be understood that the appended drawings are not necessarily to scale, presenting a somewhat simplified representation of various preferred features illustrative of the basic principles of embodiments of the invention. The specific design features of embodiments of the present disclosure as disclosed herein, including, for example, specific dimensions, orientations, locations, and shapes, will be determined in part by the particular intended application and use environment.

In the figures, reference numbers refer to the same or equivalent parts of embodiments of the present disclosure throughout the several figures of the drawings.

### DETAILED DESCRIPTION OF ILLUSTRATIVE EMBODIMENTS

The above-described objects, other objects, advantages, and features of embodiments of the present disclosure will become apparent from the descriptions of embodiments given hereinbelow with reference to the accompanying drawings. However, the present disclosure is not limited to the embodiments disclosed herein and may be implemented in various different forms. The embodiments are provided to make the description of the present disclosure thorough and to fully convey the scope of the present disclosure to those skilled in the art.

In the following description of the embodiments, the same elements are denoted by the same reference numerals even when they are depicted in different drawings. In the drawings, the dimensions of structures may be exaggerated compared to the actual dimensions thereof, for clarity of description. In the following description of the embodiments, terms, such as “first” and “second”, may be used to describe various elements but do not limit the elements. These terms are used only to distinguish one element from other elements. For example, a first element may be named a second element, and similarly, a second element may be named a first element, without departing from the scope and spirit of the invention. Singular expressions may encompass plural expressions, unless they have clearly different contextual meanings.

In the following description of the embodiments, terms such as “including”, “comprising”, and “having” are to be interpreted as indicating the presence of characteristics, numbers, steps, operations, elements, or parts stated in the description or combinations thereof, and do not exclude the presence of one or more other characteristics, numbers, steps, operations, elements, parts, or combinations thereof, or the possibility of adding the same. In addition, it will be understood that when a part, such as a layer, a film, a region, or a plate, is said to be “on” another part, the part may be located “directly on” the other part or other parts may be interposed between the two parts. In the same manner, it will be understood that when a part, such as a layer, a film, a region, or a plate, is said to be “under” another part, the part may be located “directly under” the other part or other parts may be interposed between the two parts.

All numbers, values, and/or expressions representing amounts of components, reaction conditions, polymer compositions, and blends used in the description are approximations in which various uncertainties in measurement generated when these values are acquired from essentially different things are reflected and thus it will be understood that they are modified by the term “about”, unless stated otherwise. In addition, it will be understood that, if a numerical range is disclosed in the description, such a range includes all continuous values from a minimum value to a maximum value of the range, unless stated otherwise. Further, if such a range refers to integers, the range includes all integers from a minimum integer to a maximum integer, unless stated otherwise.

FIG. 1 is a longitudinal-sectional view of an all-solid-state battery 1 according to embodiments of the present disclosure. The all-solid state battery 1 may include a solid electrolyte membrane 10, a cathode 20 disposed on one surface of the solid electrolyte membrane 10, and an anode 30 disposed on the other surface of the solid electrolyte membrane 10.

The cathode 20 may include a cathode active material which may reversibly intercalate and disintercalate lithium ions.

The cathode active material may include at least one selected from the group consisting of LiCoO₂, Li(NiₓCo_{y}Mn_{z})O₂ (x+y+z=1), Li(NiₓCo_{y}Al_{z})O₂(x+y+z=1), LiFePO₄, and combinations thereof.

The cathode 20 may include a solid electrolyte having lithium ion conductivity.

The solid electrolyte may include a sulfide-based solid electrolyte and/or an oxide-based solid electrolyte.

The sulfide-based solid electrolyte may include at least one selected from the group consisting of Li₆PS₅X (X═Cl, Br or I), Li₁₀GeP₂S₁₂, Li₃PS₄, Li₇P₃S₁₁, and combinations thereof.

The oxide-based solid electrolyte may include perovskite-type LLTO (Li₃ₓLa_{2/3-x}TiO₃), phosphate-based NASICON-type LATP(Li₁₊ₓAlₓTi₂₋ₓ(PO₄)₃), or the like.

The cathode 20 may further include a conductive material, a binder, etc.

The conductive material may include carbon black, conductive graphite, ethylene black, graphene, or the like.

The binder may include butadiene rubber (BR), nitrile butadiene rubber (NBR), hydrogenated nitrile butadiene rubber (HNBR), polyvinylidene fluoride (PVDF), polytetrafluoroethylene (PTFE), carboxymethyl cellulose (CMC), or the like.

The anode 30 may include lithium metal or a lithium alloy.

The lithium alloy may include an alloy of lithium and a metal or a metalloid which is alloyable with lithium. The metal or the metalloid which is alloyable with lithium may include Si, Sn, Al, Ge, Pb, Bi, Sb, or the like.

The thickness of the anode 30 may be about 10 μm to 200 μm.

The solid electrolyte membrane 10 may be provided in the form of a self-supporting membrane. Here, the solid electrolyte membrane 10 provided in the form of the self-supporting membrane may indicate the state in which the solid electrolyte membrane 10 may maintain the form thereof without any additional element such as a sheet or a film attached thereto.

The thickness of the solid electrolyte membrane 10 may be about 50 μm to 250 μm. Since the thickness of the solid electrolyte membrane 10 is ½ to 1/10 of the thicknesses of conventional solid electrolyte membranes, the energy density of the all-solid-state battery 1 is greatly improved.

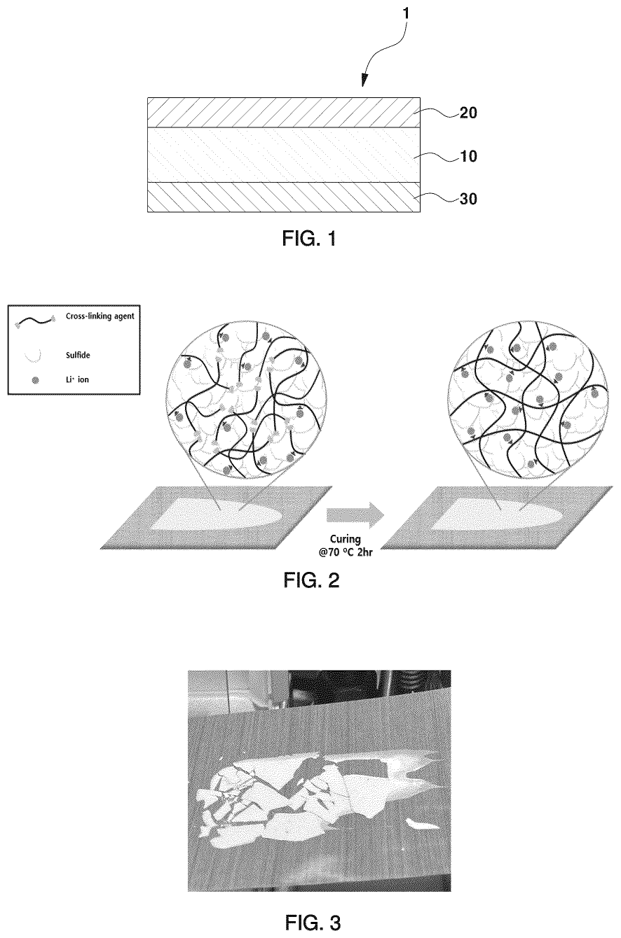

The solid electrolyte membrane 10 may include a cross-linked product of a composition including a sulfide-based solid electrolyte and a cross-linking agent. FIG. 2 is a reference view for illustrating the solid electrolyte membrane 10 according to embodiments of the present disclosure. The solid electrolyte membrane 10 is manufactured by cross-linking the composition including the sulfide-based solid electrolyte, the cross-linking agent having lithium ion conductivity, a lithium salt, etc., and the cross-linking agent having lithium ion conductivity may participate in cross-linking reaction so as to form the solid electrolyte membrane 10 having a three-dimensional network structure having excellent mechanical properties.

The sulfide-based solid electrolyte may include at least one selected from the group consisting of Li₆PS₅X (X═Cl, Br or I), Li₁₀GeP₂S₁₂, Li₃PS₄, Li₇P₃S₁₁, and combinations thereof.

The cross-linking agent may include two or more acrylate functionalities. The cross-linking agent may include at least one selected from the group consisting of tetraethylene glycol diacrylate (TEGDA), polyethylene glycol diacrylate (PEGDA), trimethylolpropane trimethacrylate, and combinations thereof. The cross-linking agent may include two acrylate functionalities, which enables polymerization reaction, at ends of the cross-linking agent, and may thus perform cross-linking reaction through radical polymerization. Particularly, tetraethylene glycol diacrylate (TEGDA) includes ethylene oxide unit, and thus has excellent ion dissociation and transfer capabilities.

The composition may include about 10 parts by weight to 15 parts by weight of the cross-linking agent based on 100 parts by weight of the sulfide-based solid electrolyte. When the content of the cross-linking agent is less than 10 parts by weight, the physical properties of the solid electrolyte membrane 10 may be deteriorated.

The composition may further include the lithium salt. The lithium salt may include at least one selected from the group consisting of LiN(SO₂F)₂, LiN(SO₂C₂F₅)₂, LiN(SO₂C₂F₃)₂, LiN(CF₃SO₂)₂, LiPF₆, LiBF₄, LiClO₄, LiCF₃SO₃, LiC₄F₉O₃, LiC₆H₅SO₃, LiSCN, LiB(C₂O₄)₂, LiPO₂F₂, and combinations thereof. When the lithium salt is added to the composition, flexibility and lithium ion conductivity of the solid electrolyte membrane 10 may be improved.

The composition may include about 15 parts by weight to 20 parts by weight of the lithium salt based on 100 parts by weight of the sulfide-based solid electrolyte. When the content of the lithium salt is less than 15 parts by weight, the improvement effect of flexibility and lithium ion conductivity of the solid electrolyte membrane 10 is not sufficient.

The composition may further include a solvent. The solvent may include at least one selected from the group consisting of N-butyl butyrate, benzyl acetic acid, 1,4-dichlorobutane, dichlorobenzene, and combinations thereof.

The content of the solvent is not limited to a specific value. For example, the composition may include about 400 parts by weight to 800 parts by weight based on 100 parts by weight of the cross-linking agent. When the content of the solvent is excessively large, the drying time of the composition may be lengthened.

The composition may further include an initiator. The initiator may include at least one selected from the group consisting of t-amyl-based compounds, azobis-based compounds, and combinations thereof. The t-amyl-based compounds may include t-amyl peroxy-2-ethylhexanoate, t-amyl peroxypivalate, t-amyl peroxyneodecanoate, t-amyl peroxyacetate, t-amyl peroxyisopropylcarbonate, t-amyl peroxy-3,5,5-trimethylhexanoate, etc. The azobis-based compounds may include 2,2′-azobisisobutyronitrile (AIBN), 2,2′-azobis-(2,4-dimethylvaleronitrile), 2,2′-azobis-(4-methoxy-2,4-dimethylvaleronitrile), etc.

The content of the initiator is not limited to a specific content. For example, the composition may include about 0.1 parts by weight to 10 parts by weight of the initiator based on 100 parts by weight of the cross-linking agent.

The solid electrolyte membrane 10 may be manufactured by cross-linking the composition. The composition may be cross-linked using a thermal cross-linking method, a photo-cross-linking method, or the like, without being limited thereto. An appropriate method may be selected depending on the kind of the cross-linking agent used. For example, the composition may be heated at a temperature of about 50° C. to 90° C. so as to be cross-linked.

Hereinafter, embodiments of the present disclosure will be described in more detail through the following examples. The following examples serve merely to exemplarily describe embodiments of the present disclosure and are not intended to limit the scope of the invention.

### COMPARATIVE EXAMPLE 1

A solid electrolyte membrane having a thickness of 750 μm was manufactured by pressing 100 mg of Li₆PS₅Cl having an argyrodite-type crystal structure at room temperature and a pressure of 300 MPa.

### EXAMPLES 1 AND 2 AND COMPARATIVE EXAMPLE 2

Compositions were manufactured by putting 100 mg of Li₆PS₅Cl having an argyrodite-type crystal structure into N-butyl butyrate serving as a solvent, adding 5 mg (Comparative Example 2), 10 mg (Example 1), and 15 mg (Example 2) of tetra(ethylene glycol) diacrylate (TEGDA) serving as a cross-linking agent thereto, and then adding 1 parts by weight of 2,2′-azobisisobutyronitrile (AIBN) serving as an initiator based on 100 parts by weight of the cross-linking agent thereto. 600 parts by weight of N-butyl butyrate, which is a stable solvent to Li₆PS₅Cl, was used based on 100 parts by weight of the cross-linking agent.

Solid electrolyte membranes were manufactured by casting the compositions onto release papers and performing thermal cross-linking at a temperature of 70° C. for 2 hours. The residual solvent was removed from the solid electrolyte membranes by drying the solid electrolyte membranes in a vacuum oven at a temperature of 70° C. for 12 hours.

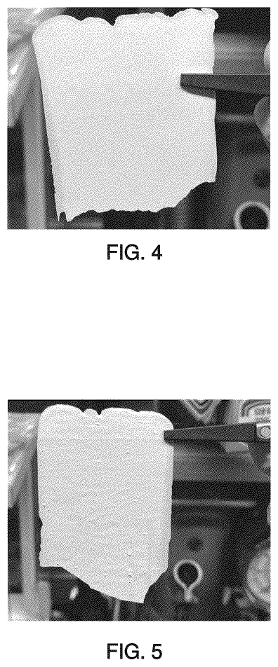

FIG. 3 is a photograph showing the result of observation of the solid electrolyte membrane according to Comparative Example 2. FIG. 4 is a photograph showing the result of observation of the solid electrolyte membrane according to Example 1. FIG. 5 is a photograph showing the result of observation of the solid electrolyte membrane according to Example 2. The solid electrolyte membrane according to Comparative Example 2, in which 5 parts by weight of the cross-linking agent was used based on 100 parts by weight of the sulfide-based solid electrolyte, had weak mechanical properties and was easily broken. On the other hand, the solid electrolyte membranes according to Examples 1 and 2, in which 10 parts by weight and 15 parts by weight of the cross-linking agent were used, had excellent mechanical properties and thus stably maintained the form of a self-supporting membrane.

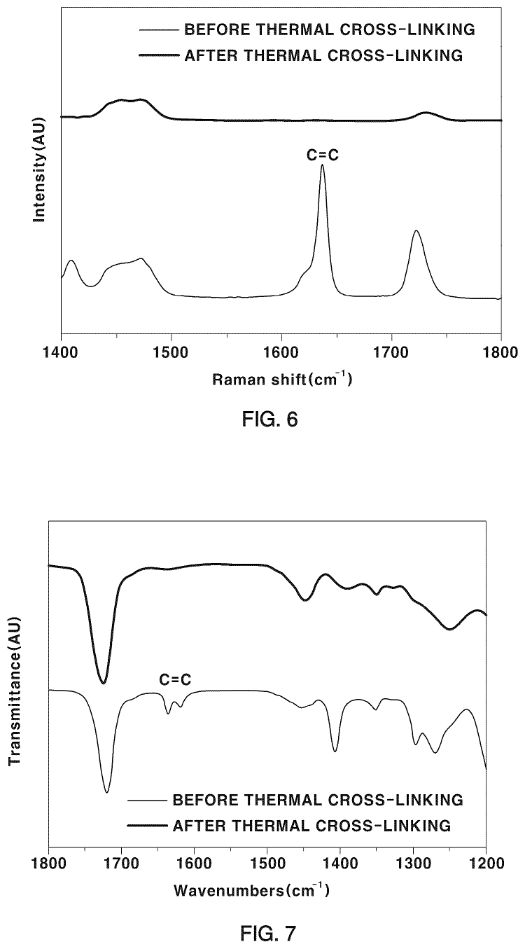

FIG. 6 is a graph representing the results of Raman spectroscopy analysis of the solid electrolyte membrane according to Example 1 before and after thermal cross-linking. FIG. 7 is a graph representing the results of infrared spectroscopy analysis of the solid electrolyte membrane according to Example 1 before and after thermal cross-linking. It may be confirmed from removal of a C═C double bond peak on the Raman spectrum and the IR spectrum that cross-linking reaction occurred through thermal cross-linking.

### COMPARATIVE EXAMPLES 3 AND 4 AND EXAMPLES 3 AND 4

Compositions were manufactured by putting 10 mg of Li₆PS₅Cl having an argyrodite-type crystal structure and 10 mg of TEGDA serving as a cross-linking agent into 60 mg of N-butyl butyrate, adding 1 parts by weight of AIBN serving as an initiator based on wo pails by weight of the cross-linking agent, and mixing 5 mg (Comparative Example 3), 10 mg (Comparative Example 4), 15 mg (Example 3), and 20 mg (Example 4) of lithium bis(trifluoromethanesulfonyl)imide (LiTFSI) serving as a lithium salt therewith.

Solid electrolyte membranes were manufactured by casting the compositions onto release papers and performing thermal cross-linking at a temperature of 70° C. for 2 hours. The residual solvent was removed from the solid electrolyte membranes by drying the solid electrolyte membranes in a vacuum oven at a temperature of 70° C. for 12 hours.

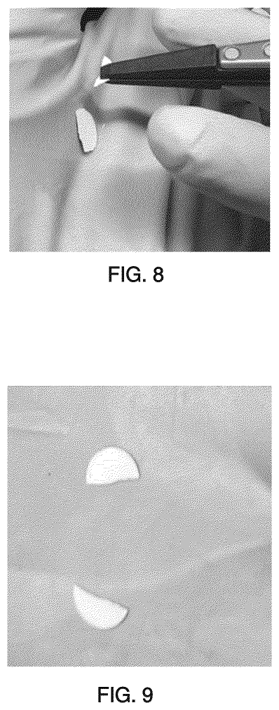

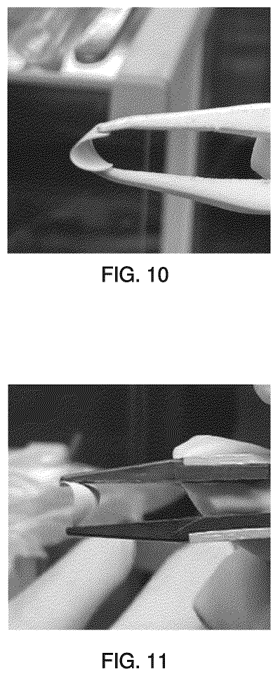

FIG. 8 is a photograph showing the result of observation of the solid electrolyte membrane according to Comparative Example 3. FIG. 9 is a photograph showing the result of observation of the solid electrolyte membrane according to Comparative Example 4. FIG. 10 is a photograph showing the result of observation of the solid electrolyte membrane according to Example 3. FIG. 11 is a photograph showing the result of observation of the solid electrolyte membrane according to Example 4. The solid electrolyte membranes according to Examples 3 and 4, in which 15 parts by weight and 20 pails by weight of the lithium salt were added based on the 100 parts by the cross-linking agent, had excellent flexibility.

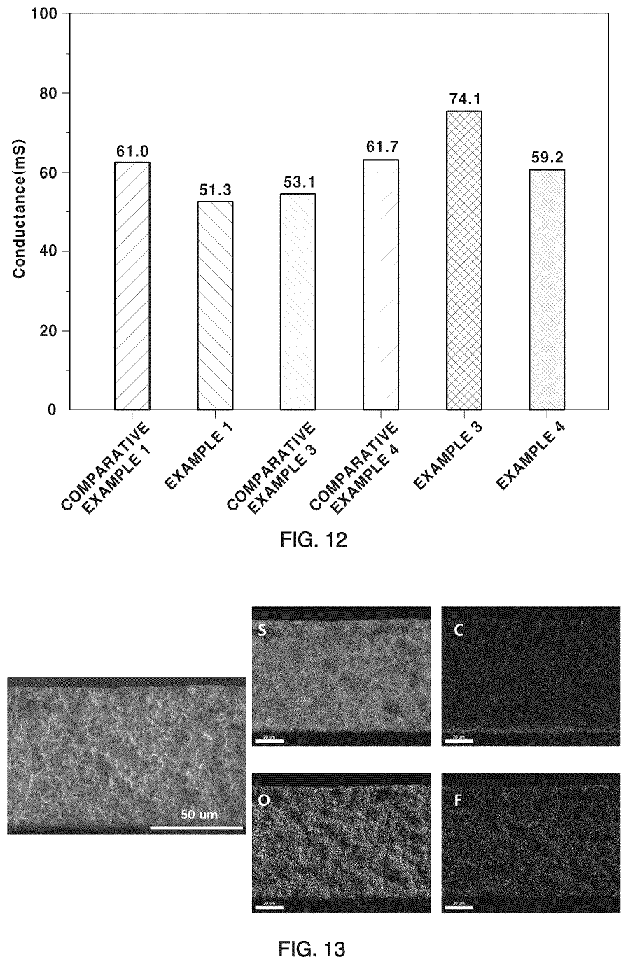

FIG. 12 is a graph representing the results of measurement of the conductance of the solid electrolyte membranes according to Comparative Examples 1, 3, and 4 and Examples 1, 3, and 4. In order to improve the charging and discharging characteristics of an all-solid-state battery, it is very important to reduce the resistance of a solid electrolyte membrane. The inverse of the resistance may be expressed as conductance, as shown in the equation below, and it is desirable for the solid electrolyte membrane to have high conductance.

$$Conductance = \frac{1}{Resistance} = \frac{Ionic Conductivity \times Area of Electrolyte}{Thickness of Electrolyte}$$

The solid electrolyte membrane according to Example 3 exhibited higher conductance than the solid electrolyte membranes according to Comparative Examples 1, 3, and 4. Therefore, when the solid electrolyte membrane according to embodiments of the present disclosure is used, an all-solid-state battery having excellent charging and discharging characteristics may be acquired.

FIG. 13 shows images representing the results of scanning electron microscopy (SEM) analysis and energy dispersive X-ray spectroscopy (EDX) analysis of the cross-section of the solid electrolyte membrane according to Example 3. It may be confirmed that the sulfide-based solid electrolyte, the lithium salt, and the cross-linking agent were strongly combined together in the solid electrolyte membrane without any empty space through the results of scanning electron microscopy (SEM) analysis. Further, it may be confirmed from the mapping images of respective elements, in which element S in the sulfide-based solid electrolyte, elements C and O in TEGDA, and element F in LiTFSI are uniformly distributed, that the respective elements in the solid electrolyte membrane are uniformly distributed, through the results of energy dispersive X-ray spectroscopy (EDX) analysis.

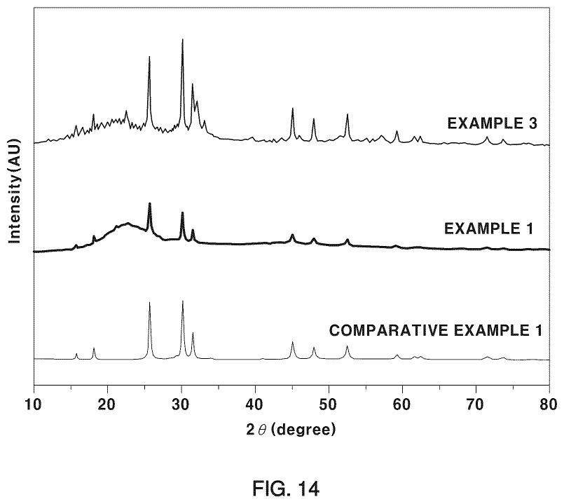

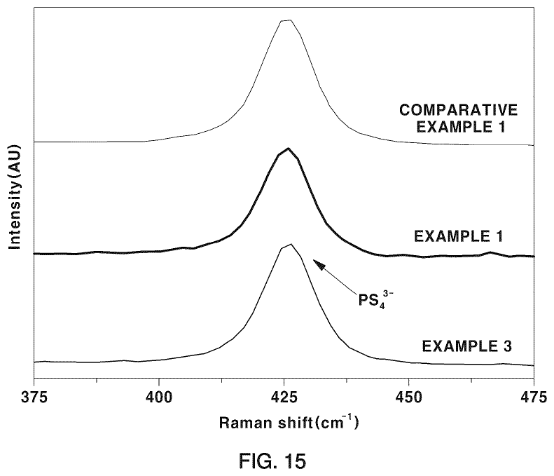

FIG. 14 is a graph representing the results of X-ray diffraction analysis of the solid electrolyte membranes according to Comparative Example 1 and Examples 1 and 3. FIG. 15 is a graph representing the results of Raman spectroscopy analysis of the solid electrolyte membranes according to Comparative Example 1 and Examples 1 and 3.

From the fact that the solid electrolyte membranes according to Comparative Example 1 and Examples 1 and 3 have the same XRD pattern, as shown in FIG. 14, and the PS₄_{^{3−}} peaks of the solid electrolyte membranes according to Examples 1 and 3 coincide with the PS₄_{^{3−}} peak of the solid electrolyte membrane according to Comparative Example 1, it may be confirmed that the sulfide-based solid electrolytes are stably present without side reactions in the solid electrolyte membranes according to Examples 1 and 3.

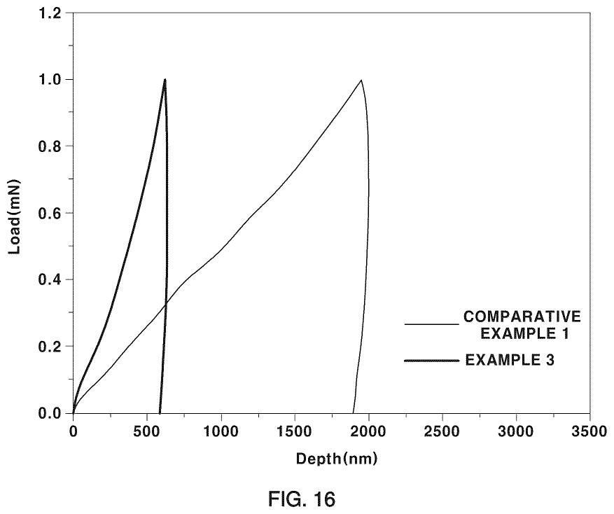

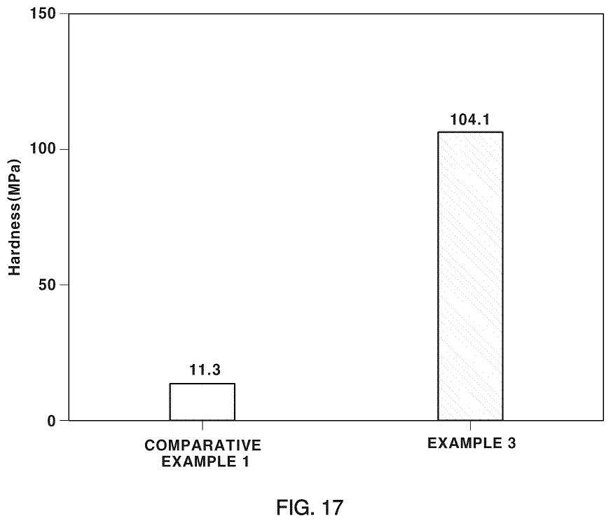

FIG. 16 is a graph representing the results of nanoindentation measurement of the solid electrolyte membranes according to Comparative Example 1 and Example 3. A nanoindentation test was performed by pressing the tip of a nanoindenter against the surfaces of the respective solid electrolyte membranes at the indentation load of 1 mN at maximum. The mechanical characteristics of the solid electrolyte membranes were checked by measuring the depths of the solid electrolyte membranes after nanoindentation. FIG. 17 is a graph representing the results of measurement of the hardness of the solid electrolyte membranes according to Comparative Example 1 and Example 3.

From the fact that the indentation depth of the solid electrolyte membrane according to Example 3 is smaller than the indentation depth of the solid electrolyte membrane according to Comparative Example 1, as shown in FIG. 16, and the hardness of the solid electrolyte membrane according to Example 3 is greater than the hardness of the solid electrolyte membrane according to Comparative Example 1, it may be confirmed that the mechanical properties of the solid electrolyte membrane according to embodiments of the present disclosure are excellent.

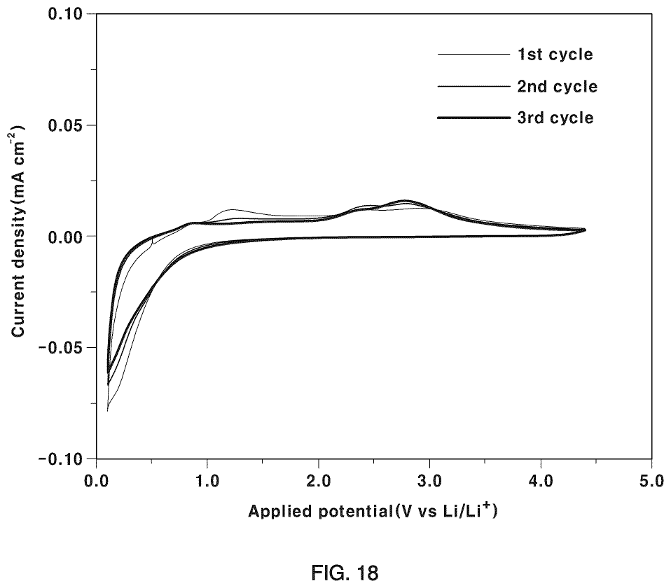

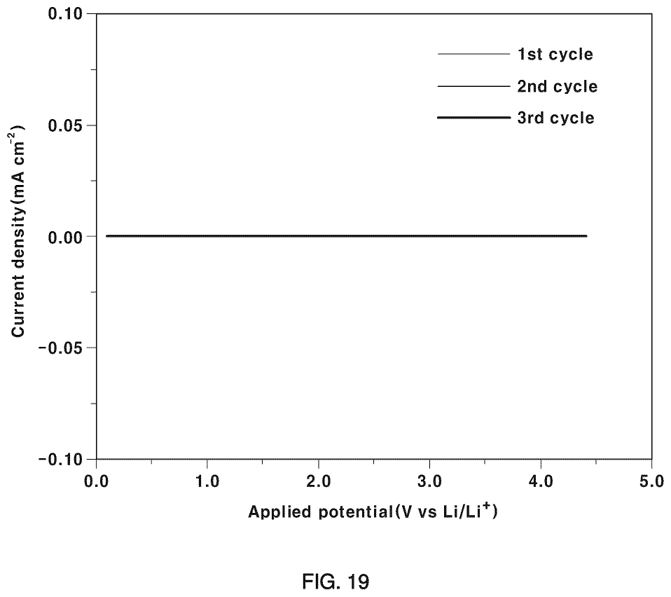

FIG. 18 is a graph representing the results of evaluation of electrochemical stability of the solid electrolyte membrane according to Comparative Example 1. FIG. 19 is a graph representing the results of evaluation of electrochemical stability of the solid electrolyte membrane according to Example 3. Cells having a lithium/solid electrolyte membrane/SUS structure were manufactured using the respective solid electrolyte membranes, lithium as counter and reference electrodes, and SUS as working electrodes, and electrochemical stabilities of the cells were evaluated using cyclic voltammetry. Here, lithium used as the counter and reference electrodes was lithium metal having a thickness of 20 μm. Cyclic voltammetry was performed at a scan rate of 1 mV·s⁻¹ within a voltage range of 0.1V to 4.4 V. It may be confirmed that the oxidation and reduction current peaks of the cell according to Example 3 were reduced compared to the cell according to Comparative Example 1. This result indicates that the electrochemical stability of the solid electrolyte membrane according to embodiments of the present disclosure is excellent.

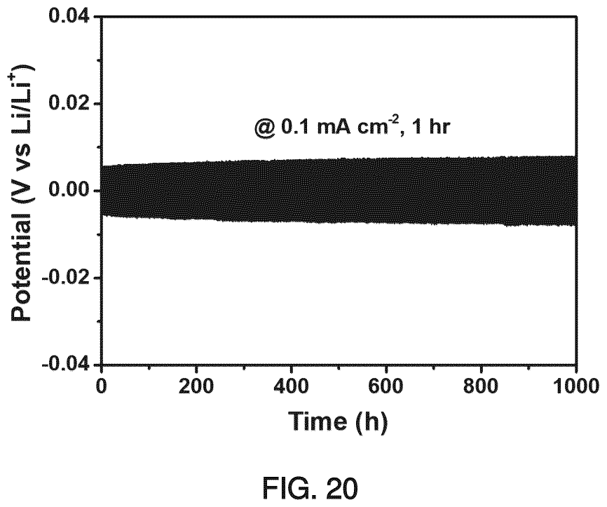

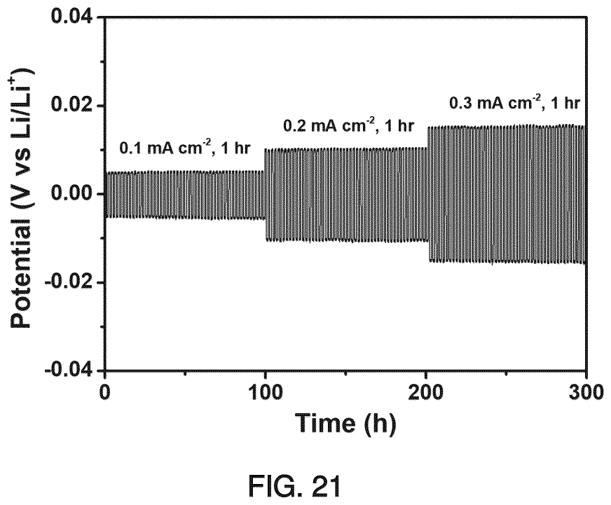

FIG. 20 is a graph representing the result of evaluation of cell performance of the solid electrolyte membrane according to Example 3 at a specific current density. FIG. 21 is a graph representing the results of evaluation of cell performance of the solid electrolyte membrane according to Example 3 while varying the current density. A symmetric cell having a lithium/solid electrolyte membrane/lithium structure was manufactured using the solid electrolyte membrane according to Example 3, and the charging and discharging characteristics of the cell were evaluated. When the symmetric cell is manufactured, lithium metal having a thickness of 20 μm was used. It may be confirmed that the solid electrolyte membrane was very stable to a lithium anode, and thus cycles of deposition and stripping of lithium were stably executed at a current density of 0.1 mA·cm⁻² (charge amount: 0.1 mA·cm⁻²) for 1,000 hours without greatly increasing overvoltage. Further, it may be confirmed that, even when the current density was increased from 0.1 mA·cm⁻² to 0.2 mA·cm⁻² and 0.3 mA·cm⁻² (charge amount: 0.1, 0.2, and 0.3 mA·cm⁻²), the cycles of deposition and stripping of lithium were stably executed without increasing overvoltage or causing a short-circuit in the cell. These results indicate that the solid electrolyte membrane according to embodiments of the present disclosure has excellent interfacial characteristics with the lithium electrode, and oxidation and reduction reactions of lithium (Li⇄Li⁺+e) smoothly occur at the interface between the electrode and the electrolyte membrane.

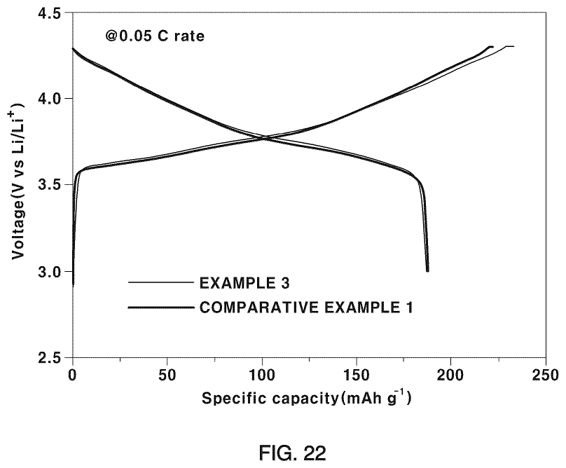

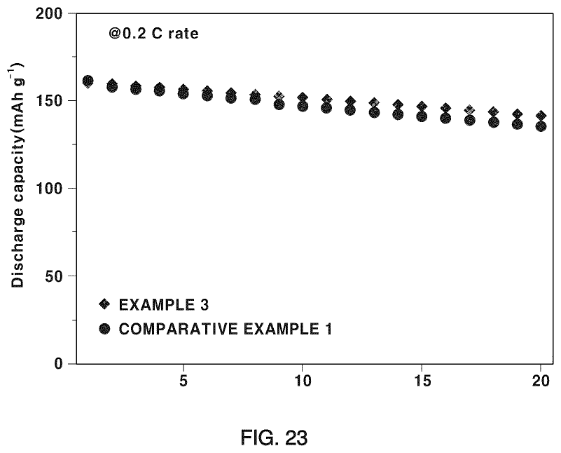

FIG. 22 is a graph representing initial charging and discharging curves of all-solid-state batteries including the solid electrolyte membranes according to Comparative Example 1 and Example 3. FIG. 23 is a graph representing the discharge capacities of the all-solid-state batteries including the solid electrolyte membranes according to Comparative Example 1 and Example 3 in respective cycles.

Lithium metal having a thickness of 20 μm and a LiNi_{0.7}Co_{0.15}Mn_{0.15}O₂-based composite cathode were respectively used as an anode and a cathode, and copper and aluminum were respectively used as an anode current collector and a cathode current collector. The composite cathode included LiNi_{0.7}Co_{0.15}Mn_{0.15}O₂ serving as an active material, a sulfide-based solid electrolyte, and vapor-grown carbon fiber (VGCF), which were mixed in a weight ratio of 70:27:3.

FIG. 22 shows the charging and discharging curves of the respective all-solid-state batteries in the first cycle, acquired by charging and discharging the all-solid-state batteries at a current rate of 0.05 C in formation cycles. It may be confirmed that the all-solid-state batteries including the solid electrolyte membranes according to Example 3 and Comparative Example 1 respectively exhibited discharge capacities of 186.9 and 187.5 mAh/g based on the cathode active material, and thus there was no significant difference between the discharge capacities of the respective all-solid-state batteries.

FIG. 23 shows the discharge capacities of the respective all-solid-state batteries in the respective cycles, acquired by charging and discharging the all-solid-state batteries at a current rate of 0.2 C. The all-solid-state battery including the solid electrolyte membrane according to Example 3 exhibited an initial discharge capacity of 160.1 mAh/g and underwent charge and discharge cycles without any short-circuit in the all-solid-state battery.

As is apparent from the above description, embodiments of the present disclosure provide a solid electrolyte membrane for all-solid-state batteries which has a small thickness.

Embodiments of the present disclosure provide a solid electrolyte membrane for all-solid-state batteries which has excellent mechanical properties, such as hardness and flexibility.

Embodiments of the present disclosure provide a solid electrolyte membrane for all-solid-state batteries which has excellent lithium ion conductivity.

Embodiments of the present disclosure provide a solid electrolyte membrane for all-solid-state batteries which has high stability to a lithium anode.

Embodiments of the present disclosure provide a solid electrolyte membrane for all-solid-state batteries which has excellent charging and discharging characteristics.

Embodiments of the invention have been described in detail with reference to preferred embodiments thereof. However, it will be appreciated by those skilled in the art that changes may be made in these embodiments without departing from the principles and spirit of the invention, the scope of which is defined in the appended claims and their equivalents.

What is claimed is:

1. A composition for solid electrolyte membranes of all-solid-state batteries, the composition comprising:
a sulfide-based solid electrolyte; and
a cross-linking agent comprising two or more acrylate functionalities.

2. The composition of claim 1, wherein the sulfide-based solid electrolyte comprises an electrolyte selected from the group consisting of Li₆PS₅X (X═Cl, Br or I), Li₁₀GeP₂S₁₂, Li₃PS₄, and Li₇P₃S₁₁ and any combination thereof.

3. The composition of claim 1, wherein the cross-linking agent comprises a cross-linking agent selected from the group consisting of tetraethylene glycol diacrylate (TEGDA), polyethylene glycol diacrylate (PEGDA), and trimethylolpropane trimethacrylate and any combination thereof.

4. The composition of claim 1, wherein the composition comprises the cross-linking agent in an amount of 10 parts by weight to 15 parts by weight based on 100 parts by weight of the sulfide-based solid electrolyte.

5. The composition of claim 1, wherein the composition further comprises a lithium salt that is selected from the group consisting of LiN(SO₂F)₂, LiN(SO₂C₂F₅)₂, LiN(SO₂C₂F₃)₂, LiN(CF₃SO₂)₂, LiPF₆, LiBF₄, LiClO₄, LiCF₃SO₃, LiC₄F₉O₃, LiC₆H₅SO₃, LiSCN, LiB(C₂O₄)₂, and LiPO₂F₂ and any combination thereof.

6. The composition of claim 5, wherein the composition comprises the lithium salt in an amount of 15 parts by weight to 20 parts by weight based on 100 parts by weight of the sulfide-based solid electrolyte.

7. The composition of claim 1, further comprising a solvent, selected from the group consisting of N-butyl butyrate, benzyl acetic acid, 1,4-dichlorobutane, and dichlorobenzene and any combination thereof.

8. The composition of claim 1, further comprising an initiator selected from the group consisting of t-amyl-based compounds and azobis-based compounds and combinations thereof.

9. A solid electrolyte membrane for an all-solid-state battery, the solid electrolyte membrane comprising a cross-linked product of the composition of claim 1.

10. The solid electrolyte membrane of claim 9, wherein the solid electrolyte membrane is a self-supporting membrane.

11. The solid electrolyte membrane of claim 9, wherein the solid electrolyte membrane has a thickness of 50 μm to 250 μm.

12. A method of manufacturing a solid electrolyte membrane for an all-solid-state battery, the method comprising:
forming a composition comprising:
a sulfide-based solid electrolyte; and
a cross-linking agent comprising two or more acrylate functionalities; and
cross-linking the composition.

13. The method of claim 12, wherein cross-linking the composition comprises heating the composition to a temperature of 50° C. to 90° C.

14. The method of claim 12, wherein the solid electrolyte membrane is formed to have a thickness of 50 μm to 250 μm.

15. An all-solid-state battery comprising:
a cathode;
an anode; and
a solid electrolyte membrane disposed between the cathode and the anode, the solid electrolyte membrane comprising a cross-linked composition comprising a sulfide-based solid electrolyte and a cross-linking agent comprising two or more acrylate functionalities.

16. The all-solid-state battery of claim 15, wherein the anode comprises lithium metal or a lithium alloy.

17. The all-solid-state battery of claim 15, wherein the anode has a thickness of 10 μm to 200 μm.

18. The all-solid-state battery of claim 15, wherein the cathode comprises a cathode active material selected from the group consisting of LiCoO₂, Li(NiₓCo_{y}Mn_{z})O₂ (x+y+z=1), Li(NiₓCo_{y}Al_{z})O₂ (x+y+z=1), and LiFePO₄ and any combination thereof.

19. The all-solid-state battery of claim 15, wherein the solid electrolyte membrane has a thickness of 50 μm to 250 μm.

20. The all-solid-state battery of claim 15, wherein the sulfide-based solid electrolyte comprises a solid electrolyte selected from the group consisting of Li₆PS₅X (X═Cl, Br or I), Li₁₀GeP₂S₁₂, and Li₃PS₄, Li₇P₃S₁₁, and any combination thereof.
